(19) United States
(12) Patent Application Publication
(10) Pub. No.: US 2026/0269694 A1
(43) Pub. Date: Sep. 10, 2026

(54) Rotor Arrangement, Electric Machine and Electric Axle Drive

(71) Applicant: ZF Friedrichshafen AG, Friedrichshafen (DE)

(72) Inventors: Thomas Meinerz, Friedrichshafen (DE); Michael Griesbach, Tettnang (DE); Sebastian Schuhmacher, Friedrichshafen (DE)

(21) Appl. No.: 19/562,110

(22) Filed: Mar. 10, 2026

(30) Foreign Application Priority Data
Mar. 10, 2025 (DE) 102025109043.2

(51) Int. Cl. H02K 11/40; B60K 1/00

(52) U.S. Cl. CPC H02K 11/40; B60K 1/00

(57) ABSTRACT

A rotor arrangement for an electric machine includes a rotor and a grounding device. The grounding device has a contact element for electrically contacting the rotor, with the contact element being axially movable relative to the rotor.

### CROSS-REFERENCE TO RELATED APPLICATION

The present application is related and has right of priority to German Patent Application No. 10 2025 109 043.2 filed on Mar. 10, 2025, the entirety of which is incorporated by reference for all purposes.

### FIELD OF THE INVENTION

The invention relates generally to a rotor arrangement for an electric machine having a rotor and a grounding device, wherein the grounding device has a contact element for electrically contacting the rotor and a holding device for accommodating the contact element.

### BACKGROUND

Electric machines are used in the automotive field in order to design the motor vehicle as a hybrid or electric vehicle. Electric machines are also provided in some motor vehicle transmissions in order to make the motor vehicle transmission suitable for use in a hybrid vehicle or an electric vehicle. Whereas the remaining components of the transmission are enclosed and shielded by the surrounding transmission housing, the shafts which extend out of the transmission housing can induce electromagnetic interference, which, in the region of a motor vehicle, can result in a malfunction of other electronic components. In addition, a potential difference can build up between the shaft and the transmission housing, which can result in perforations on bearings of the shaft and thus in a reduction in the service life of these bearings. For this reason, the shaft concerned is to be grounded, if possible. A shaft is also to be grounded with respect to other electric machines provided in a motor vehicle, for example, electric axle drive units, in order to eliminate or reduce electromagnetic interference and to prevent the build-up of a potential difference. Grounding is usually carried out by electrically conductively connecting the shaft to be grounded to ground, which is usually a housing of the transmission, wherein the electrically conductive connection is usually implemented as a sliding contact via a guide device. In addition, arrangements for grounding a shaft are also known, in which a contact element is axially displaceable in the direction of or towards the shaft relative to the holding device with spring force in order to ensure the contact with the shaft and to compensate for wear in this region.

WO 2022/135715 A1 discloses an arrangement for grounding a shaft, which can be a rotor shaft of an electric machine. In this arrangement, an electrically conductive connection is established between the shaft and a ground as a housing in order to ground the shaft, wherein this connection is implemented as a sliding contact via an intermediate guide device. The guide device has a holding device, which is electrically conductively fastened on the ground side. In the holding device, a contact element is axially movably guided in a recess and projects with an end face on one axial side of the holding device in order to establish, at the end face, the sliding contact with the shaft located here. In order to ensure the necessary contact pressure, a spring is located axially behind the contact element, which spring is supported against the end face of the holding device.

### SUMMARY OF THE INVENTION

Proceeding from the above-described prior art, the problem addressed by the present invention is that of providing a rotor arrangement, an electric machine, and an electric axle drive, which provides an improved grounding device for establishing an electrically conductive connection between two components which are rotatable relative to one another.

A rotor is a part of electric machines which also have at least one stator. One of the two components is arranged so as to be rotatable relative to the other component, usually the rotor. In some instances, the rotor is also the rotatable component in the present invention.

The grounding device is used to electrically ground a component of the electric machine, in particular the rotor, as described above. Due to the grounding device, an electrically conductive connection is established between two components which are rotatable relative to one another. The grounding device is therefore at least partially electrically conductive.

To this end, the grounding device has a contact element. The contact element is used to electrically contact a component, in particular instances, the rotor.

In some instances, the contact element consists of a material which is wear-resistant and, at the same time, at least partially electrically conductive. The contact element establishes the conductive connection between the component, in particular the rotor, and the ground. Of course, there are other components between the contact element and the ground that will be determined.

The contact element is arranged so as to be axially movable relative to the rotor. Axial is intended to mean an orientation parallel to the longitudinal axis of the rotor, along which the contact element is displaceable relative to the rotor. Due to the axial displacement, wear may be compensated for and an axial runout that is not perfect may be compensated for.

In some instances, the grounding device may have a holding device, wherein the holding device at least partially accommodates the contact element. The holding device accommodates the contact element in such a way that the contact element may at least touch the rotor. In one instance, the holding device may have a recess in the end face. The contact element is introduced in the recess and, here, is electrically conductively connected to the holding device. The contact element has an end face extending out of a first axial side of the holder, which end face is provided for forming an electrically conductive contact of the contact element with the other component, such as the rotor.

An electrically conducting or electrically conductive connection is understood to be a connection which brings about potential equalization between the connected components. The connection may be established directly in each case by direct contact or indirectly via further, intermediate components.

Advantageously, at least one fluid duct may be formed in the holding device, which in each case opens at the first axial side of the holder and is used to supply lubricant and/or coolant to the contact element. In some instances, the holding device is at least partially electrically conductive.

In one instance, the contact element and the holding device are fixedly connected to each other in the axial direction and the holding device is arranged so as to be axially movable relative to the rotor. In one instance and alternatively, the contact element may be arranged so as to be axially movable relative to the holding device. In such instance, the holding device may be arranged so as to be axially movable or fixed relative to the rotor.

The grounding device is provided for establishing an electrically conductive connection between two components that rotate relative to one another or that may rotate relative to one another. In some instances, this means that at least one of the two components rotates, in particular instances, exclusively one. One component is, in some instances, a housing which is electrically conductively connected to a shaft in order to ground this shaft. In particular instances, the shaft to be grounded is a rotor shaft.

The contact element has an end face which extends out of a first axial side of the holder, such that this end face of the contact element projects outwardly relative to the first axial side of the holder. In some instances, the holding device including the contact element is preloaded in the direction of the first axial side of the holder for this purpose. In some instances, this preload is implemented via a spring element which is arranged axially between the holding device and a support within the housing or a device therefor. In the installed state of the holding device, an electrically conductive sliding contact with the other component is established at the end face of the contact element, wherein the contact element is additionally electrically conductively connected to the holder, whereby the electrically conductive connection between the two components is established via the holder and the contact element together.

In some instances, the rotor arrangement has a device for applying a force onto the contact element, which device acts on the contact element in the direction of the rotor. The contact element may be fixedly mounted in the holding device and arranged so as to not be axially movable relative to the holding device. Advantageously, this arrangement makes it possible to apply a permanent force on the holding device. In this arrangement, the device for applying a force is arranged between the holding element and a support point. The force may therefore also act on the contact element indirectly. This provides the functionality of grounding the shaft and, in the event of wear of the contact element, brings about an automatic adjustment of the entire holding device. Thus, the service life of the grounding device may be extended many times over.

In addition, the grounding device may be highly compact, which is advantageous in light of the tight installation space conditions within the rotor arrangement. As a result, the grounding device is designed such that it is manufacturable in a cost-effective and functionally optimal manner.

In some instances, the device for applying a force may be a spring element.

The spring element may be advantageously arranged radially on the outer contour of the holding device. The spring element may be detachably or non-detachably connected to the holding device. In both cases, a fastening means or a support means may be provided radially on the outer contour of the holding device. The fastening means or the support means must be designed in such a way that the axially acting forces of the spring element may be absorbed and effectively transmitted by the holding device. It is also conceivable here to arrange the spring element within the holding device, wherein the spring element would then need to be supported toward the outside through openings in the holding device. Such a design of the holding device has the advantage that the functionality of pressing the holding device, including contact element, is establishable in a technically very easy and robust manner.

Advantageously, the spring element may be a disk spring. To this end, a projection may be provided radially on the outer contour of the holding device in order to transmit the axial forces from the disk spring onto the holding device. The projection for transmitting force may be detachably or non-detachably connected to the disk spring. A further option for axially transmitting force from the disk spring onto the holding device consists in placing the disk spring at the axial end of the holding device. For this purpose, a surface must be provided on the side of the holding device opposite the contact element, against which the disk spring may be supported. In some instances, this may be achieved using a radially positioned shoulder. This may also extend over the entire radially arranged surface.

In some instances, the device for applying the axial force, in particular for pressing the holding device against the shaft, may be hydraulic. In some instances, the holding device may be pressed in the direction of the shaft via at least one line (e.g., hydraulic line) and at least one piston. The piston may be located on the side of the holding device opposite the contact element. For this purpose, a means must be provided on the side of the holding device opposite the contact element, against which the piston may be supported.

In some instances, a radially extending shoulder may be attached to the holding device, in particular to the force-transmitting portion, for this purpose. This may also extend over the entire circumferential direction. In a further embodiment, the piston may act on the radial outer surface of the holding device, for example via a force transmission device, and transmit the forces onto the holding device.

In some instances, the holding device has at least one fluid duct for supplying the contact element with fluid, wherein the fluid duct extends through the holding device in the axial direction. In particular, some portions of the fluid duct may lie within the spring element. On the side of the holding device on which the contact element is arranged, the interior of the holding device may be a fluid accumulator in such a way that the fluid may be stored in the holding device and thus act as a fluid buffer. Baffles, which may decelerate a movement of the fluid, may be located on the rotor side of the bore in the interior of the holding device. Due to the implementation of the grounding device in the holding device with an integrated fluid duct, in the installed state of the holding device according to the invention, components may be mounted on the outside, such as a bearing to be provided here, which components may be optimized with respect to installation space.

In some instances, the rotor arrangement may have a bearing for supporting the holding device, which bearing supports the holding device on the shaft. If the holding device is movably arranged, a bearing may also increase the mobility of the shaft. This bearing may, in some instances, be a floating bearing. Then, the holding device extends in the axial direction but is still movable in the axial direction.

In some instances, at least two bearings may be provided for supporting the holding device. Advantageously, both bearings are floating bearings. As described above, the bearing on the shaft may be a floating bearing. The grounding device is subject to wear, which must be compensated for by the entire holding device. In particular, precisely two bearings are provided for supporting the holding device.

The bearings may be designed differently. For example, ball bearings such as sliding bearings or sliding bushings may be used. It is also possible to completely omit the bearings and the sliding bushing. If bearings and sliding bushings are omitted, it must be ensured that sufficient play is present between the holding device and the shaft so that the two components may move relative to one another.

The invention also relates to an electric machine having a rotor arrangement and a stator arrangement. The rotor arrangement is distinguished by the fact that it is designed as described above.

In some instances, the electric machine is a traction machine, i.e. an electric machine that propels a motor vehicle. Potential differences may arise therein, as described above. In order to avoid this, the rotor arrangement has a grounding device.

Advantageously, the arrangement for the rotor and the stator may be an integral part of an electric machine and may be an integral part of an axle drive unit for a motor vehicle.

The invention also relates to an electric axle drive for a motor vehicle having an electric machine and/or a rotor arrangement. The electric axle drive is distinguished by the fact that the electric machine is designed as described above and/or the rotor arrangement is designed as described above.

The invention also relates to a motor vehicle.

The electric axle drive may be installed in a motor vehicle which is operated in a hybrid manner or electrically. The electric axle drive may act on the rear axle and/or on the front axle. It makes no difference how many rear axles and/or front axles the vehicle has. Conceivably, there is at least one electric axle drive on the rear axle and/or at least one electric axle drive on the front axle. It is also conceivable to have more than one electric axle drive on each side.

### BRIEF DESCRIPTION OF THE DRAWINGS

Advantageous features, details, and embodiments of the invention can be found in the following description and in the following figures. The figures are schematic representations, wherein:

FIG. 1 shows a motor vehicle with an electric axle drive, a control unit, and an inverter.

FIG. 2 shows an electric axle drive with an electric machine.

FIG. 3 shows a drive shaft and a grounding element.

FIG. 4 shows a drive shaft and a grounding element.

FIG. 5 shows a drive shaft and a grounding element.

FIG. 6 shows a drive shaft and a grounding element.

FIG. 7 shows a grounding element

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

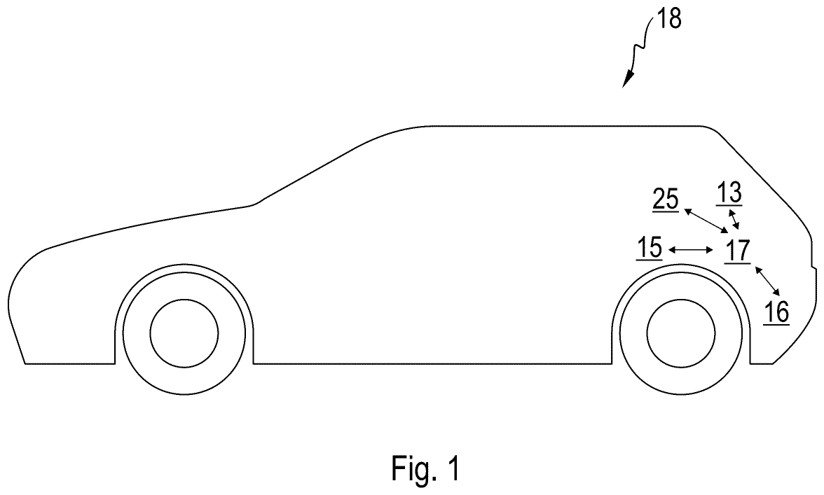

FIG. 1 shows a motor vehicle 18. The motor vehicle 18 has at least one electric axle drive 17 with an inverter 16, an electric machine 13, a transmission 25, and a control unit 15. The transmission 25 may include a pure reduction gear; alternatively, it may additionally include a differential. Further alternatively, the differential and the reduction gear may be integrated.

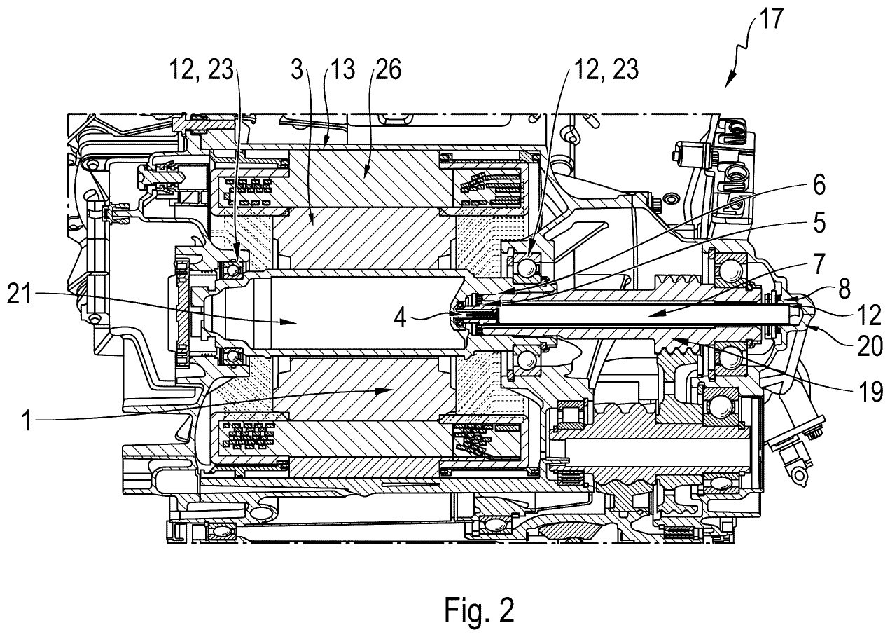

FIG. 2 shows an electric axle drive 17 with an electric machine 13 in a sectional view along the longitudinal axis. Of the electric axle drive 17, only the electric machine 13 is represented. The electric machine 13 includes at least one rotor arrangement 1 with a rotor 3 and a grounding device 4, and a stator 26.

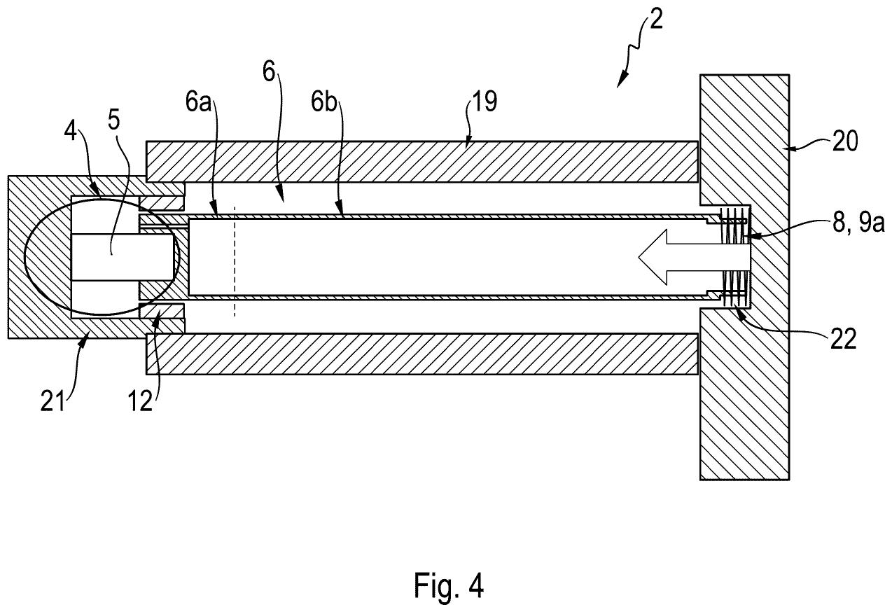

The grounding device 4 includes a holding device 6, which partly accommodates a contact element 5. The rotor shaft 21 of the rotor 3 and the grounding device 4 are arranged coaxially in series. The grounding device 4 is supported in the rotor shaft 21 via a floating bearing 12 (FIGS. 4-7).

The grounding device 4 is used to establish an electrically conductive connection between the rotor 3 and the drive shaft 19 and to the housing of the transmission 20. The grounding device 4 is therefore at least partially electrically conductive.

The grounding device 4 is supported in the housing of the transmission 20 with a sliding bearing on the side opposite the contact element 5.

Advantageously, ball bearings are used to support the grounding device 4 in the rotor shaft 21. Alternatively, it is also possible to use needle bearings or sliding bearings here. These have very good bearing properties and running properties.

As is apparent from FIG. 2, the grounding device 4 is rotationally decoupled from the rotor shaft 21. An axially parallel movement of the grounding device 4 is made possible due to the above-described mounting.

As is suggested by FIG. 2, the mounting of the rotor shaft 21 may likewise be realized using ball bearings. Here, a first bearing is a floating bearing 12 and a second bearing is a fixed bearing 23. Alternatively, it is also possible to use needle bearings or sliding bearings here.

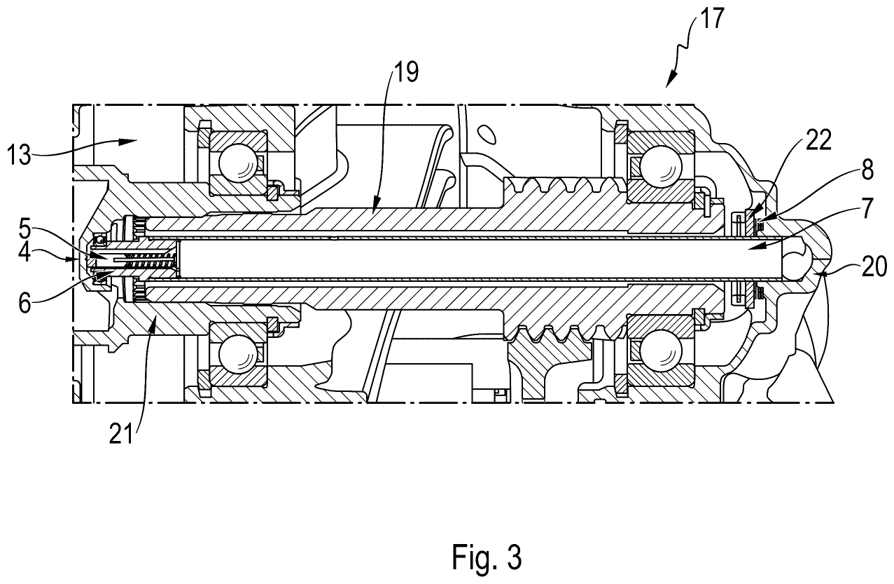

FIG. 3 shows the grounding device 4 in detail in a sectional view along the longitudinal axis of the rotor arrangement 1. The grounding device 4 has the contact element 5 and the holding device 6. As shown in FIGS. 4-7, the holding device 6 has a holding portion 6a and a force-transmitting portion 6b. The holding portion 6a and the force-transmitting portion 6b are advantageously made of an electrically conductive material, which makes it possible to dissipate the currents in the rotor shaft 21 into the housing of the transmission 20. The cooling fluid needed to cool the contact element 5 may be conducted through the force-transmitting portion 6b to the contact element 5.

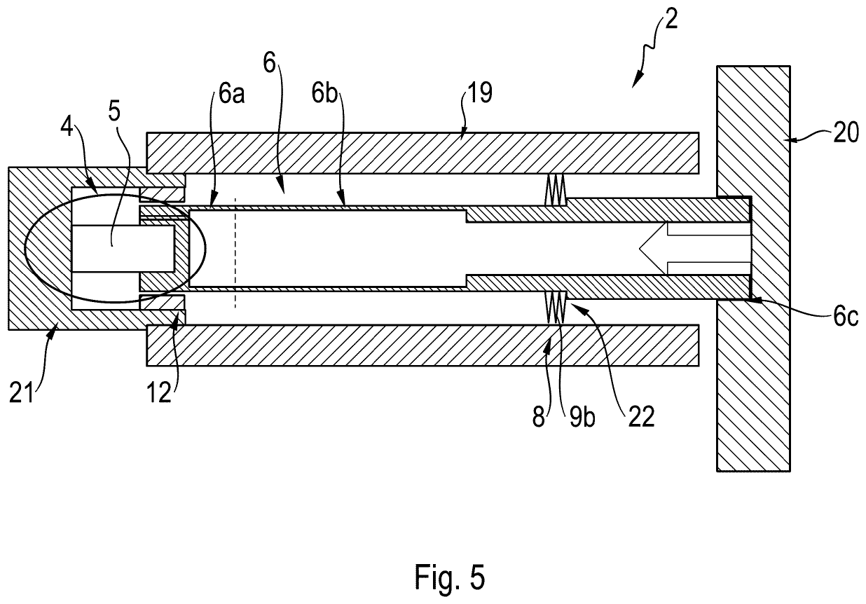

The force-transmitting portion 6b is a disk spring 9b in FIG. 5.

FIG. 4 shows the grounding device 4 in detail. A fluid flows through the force-transmitting portion 6b and the holding portion 6a, which is used at least to cool and to lubricate the contact element 5. In addition, the fluid may also be used to cool bearings. It is necessary that the fluid is under pressure. As a result, it is ensured that the fluid may be conducted through the force-transmitting portion 6b in the direction of, or towards, the contact element 5 in order to cool and lubricate the grounding device 4 at the point of contact of the rotor shaft 21 with the contact element 5.

In one preferred embodiment, the holding portion 6a projects into the force-transmitting portion 6b in such a way that the holding portion 6a and the force-transmitting portion 6b are assembled with one another.

After the assembly, the holding portion 6a is connected to the force-transmitting portion 6b in a fluid-tight manner and without play in the axial direction. This is advantageously achievable by a joining process or by applying a thread on the side of the holding portion 6a and on the side of the force-transmitting portion 6b.

The contact element 5 is, in some instances, non-detachably connected to the holding portion 6a. The contact element 5 may, in some instances, be pre-mounted in the holding portion 6a prior to the assembly of the holding portion 6a and the force-transmitting portion 6b. The contact element 5 may therefore be pressed against the rotor 3 (e.g., the rotor shaft 21) without play and in a manner that compensates for wear.

It is apparent from FIG. 4 that the force-transmitting portion 6b is pressed in the direction of, or towards, the rotor shaft 21 via a spring element 8. The spring element 8 is a coil spring 9a. The coil spring 9a is supported against the rear face of the force-transmitting portion 6b at one end and against the housing of the transmission 20 at the other end. For this purpose, a shoulder 22 may be attached to the force-transmitting portion 6b, which shoulder is non-detachably connected to the force-transmitting portion 6b. The shoulder 22 on the force-transmitting portion 6b may, in some instances, be attached either by adhesive bonding, soldering, or welding. Alternatively, the shoulder 22 may, in some instances, be attached to the force-transmitting portion 6b by a forming process. In some instances, the forming process is rolling. Due to the disclosed embodiment, a functionality that is independent of wear is ensured.

The force-transmitting portion 6b is attached to the housing in a fluid-tight but axially displaceable manner.

FIG. 5 shows a second embodiment of the invention. In this embodiment, the spring element 8 is arranged between the force-transmitting portion 6b and a support portion 6c. The spring element 8 is a disk spring 9b. Otherwise, the components are described as they are for the preceding figures.

The disk spring 9b is supported against a shoulder 22 of the support portion 6c on one side and against the housing of the transmission 20 on the other side. For this purpose, the shoulder 22 is attached to the support portion 6c, which shoulder is non-detachably connected to the support portion 6c. The shoulder 22 on the support portion 6c may be attached either by adhesive bonding, soldering, or welding. Alternatively, the shoulder 22 may be attached to the support portion 6c by a forming process. In some instances, the forming process is rolling. Due to the disclosed embodiment, a functionality that is independent of wear is ensured. The support portion 6c is attached to the housing in a fluid-tight, axially displaceable manner. The wall thicknesses of the support portion 6c, of the force-transmitting portion 6b, and of the holding portion 6a must be sufficiently dimensioned due to the occurrence of high axial forces. In some instances, the rear force-transmitting portion 6c is made of a metal material. Alternatively, in some instances, the rear force-transmitting portion 6c is made of a plastic which is electrically conductive. In some instances, the support portion 6c has the same shape as the force-transmitting portion 6b.

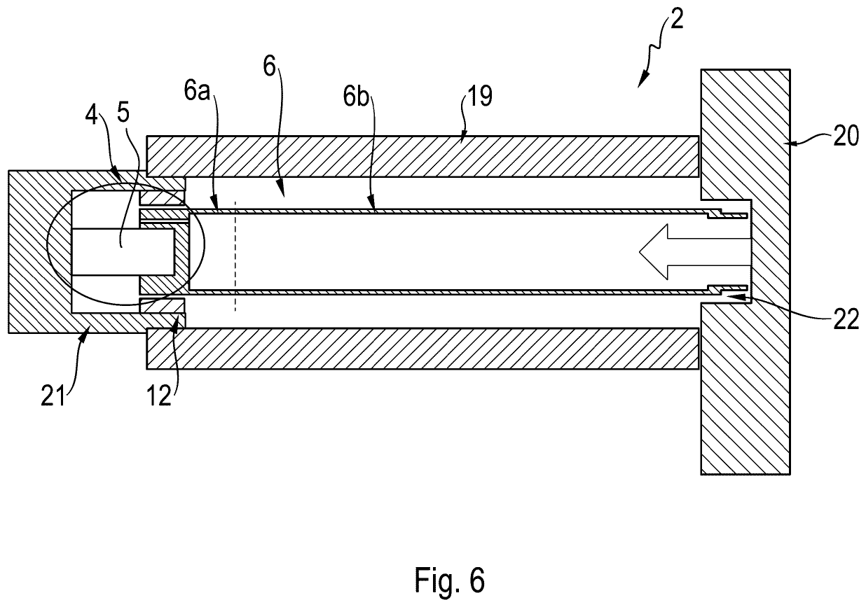

FIG. 6 shows a rotor arrangement 2 in which the device for applying a force is hydraulic. For the rest, reference is made to the components from FIG. 4.

Due to the build-up of an overpressure within the holding device 6, the entire unit may be pressed axially against the rotor shaft 21. The necessary pressure must be greater than atmospheric pressure. Thus, the absence of play and the functionality that compensates for wear is ensured.

The cooling fluid and/or lubricating fluid used to cool the contact element 5 may advantageously also be used to apply the force onto the holding device 6. For this purpose, a sufficiently dimensioned coolant pump, which is not represented in greater detail, must be provided. In addition, the passage of coolant through the holding device 6 must be designed in such a way that the pressure drop due to the passage of the coolant fluid and/or lubricating fluid through the holding device 6 may be held as low as possible. This is realized by using valves and even a restrictor, which are not represented here in greater detail. In addition, in some instances, the use of a reservoir is also conceivable, which reservoir is continuously filled by the coolant pump and thus does not induce a pressure drop. In such instances, the coolant fluid and/or lubricating fluid for cooling the contact element 5 may be tapped therefrom.

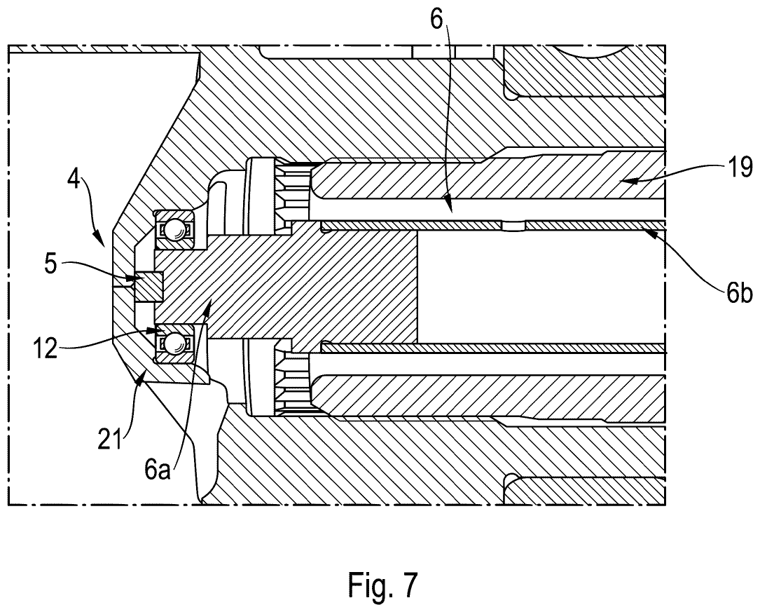

FIG. 7 shows the holding portion 6a and the force-transmitting portion 6b in a detailed view. The contact element 5, which is fixedly connected to the holding device 6, is located on the side of the holding device 6 opposite the wall of the transmission housing. The holding device 6 is supported in or at the rotor shaft 21, as described above. The grounding device 4 is, in some instances, located partially or completely within (e.g., radially within) the drive shaft 19. In one instance, an arrangement of the grounding device 4 outside the output or drive shaft 19 is possible. The advantage of arranging the grounding device 4 within the output shaft 19 is that the relative speed of the components such as rotor shaft 21 and contact element 5 is kept low. This results in low wear and tear of the contact element 5. When the grounding device 4 is arranged outside the drive shaft 19, the relative speed of the contact element 5 and of the rotor 21, and thus the wear behavior, increases overall due to the design.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 rotor arrangement
2 electric machine
3 rotor
4 grounding device
5 contact element
6 holding device
6a holding portion
6b force-transmitting portion
6c support portion
8 spring element
9a coil spring
9b disk spring
10 hydraulic device
11 fluid duct
12 floating bearing
13 electric machine
14 stator arrangement
15 control unit
16 inverter
17 electric axle drive
18 motor vehicle
19 output shaft
20 housing of the transmission
21 rotor shaft
22 shoulder
23 fixed bearing
24 shoulder
25 transmission
26 stator

1.-12. (canceled)

13. A rotor arrangement (1) for an electric machine (2), comprising:
a rotor (3); and
a grounding device (4), the grounding device (4) comprising a contact element (5) for electrically contacting the rotor (3), the contact element (5) being axially movable relative to the rotor (3).

14. The rotor arrangement (1) of claim 13, wherein the grounding device (4) comprises a holding device (6), the holding device (6) at least partially accommodating the contact element (5).

15. The rotor arrangement (1) of claim 14, wherein the holding device (6) defines at least one fluid duct (11).

16. The rotor arrangement (1) of claim 14, further comprising a bearing for supporting the holding device (6), the bearing supporting the holding device (6) on the shaft.

17. The rotor arrangement (1) of claim 16, wherein the bearing comprises a floating bearing (12).

18. The rotor arrangement (1) of claim 13, further comprising a device for applying a force (8, 9a, 9b) onto the contact element (5), the force acting on the contact element (5) in a direction towards the rotor (3).

19. The rotor arrangement (1) of claim 18, wherein the device for applying the force comprises a spring element (8).

20. The rotor arrangement (1) of claim 19, wherein the spring element (8) comprises a coil spring (9a) or a disk spring (9b).

21. The rotor arrangement (1) of claim 18, wherein the device for applying the force comprises a hydraulic device (10).

22. An electric machine (13), comprising:
a stator arrangement (14); and
the rotor arrangement (1) of claim 13.

23. An electric axle drive (17) for a motor vehicle (18), comprising:
the rotor arrangement of claim 13.

24. A motor vehicle (18), comprising the electric axle drive (17) of claim 23.
